(19) United States
(12) Patent Application Publication
(10) Pub. No.: US 2008/0097646 A1
(43) Pub. Date: Apr. 24, 2008

(54) Calibration of a substrate handling robot

(76) Inventors: Craig C. Ramsey, West Linn, OR (US); Felix J. Schuda, Saratoga, CA (US)

Correspondence Address: Christopher R. Christenson;WESTMAN, CHAMPLIN & KELLY, P.A., Suite 1400, 900 Second Avenue South, Minneapolis, MN, 55402-3319, US

(21) Appl. No.: 11/977,162

(22) Filed: Oct. 23, 2007

Related U.S. Application Data
(60) Provisional application No. 60/853,660, filed on Oct. 23, 2006.

(51) Int. Cl. G05B 15/00; G01B 21/16; G01P 21/00

(52) U.S. Cl. 700/258; 702/95; 901/3; 901/30; 901/46

(57) ABSTRACT

A method of calibrating a robot in a processing system is provided. The method includes removably coupling a distance sensor to an end effector of the robot and causing the distance sensor to measure a distance from the sensor to a substrate support. Then it is determined whether the distance meets or is within a selected threshold. Robot joint positions are recorded when the distance meets or is within the selected threshold.

### CROSS-REFERENCE TO RELATED APPLICATION

The present application is based on and claims the benefit of U.S. provisional patent application Ser. No. 60/853,660, filed Oct. 23, 2006, the content of which is hereby incorporated by reference in its entirety.

### BACKGROUND

The leading edge of the semiconductor processing industry is currently advancing production to the 65 nanometer and 45 nanometer nodes. Further, development is currently underway at the 32 nanometer and 22 nanometer nodes. Accordingly, it is increasingly critical that semiconductor processing tools and the processing itself be controlled to tolerances and conditions never previously required. The cost of wafer scrap and maintenance downtime continues to drive the desire to control processes and equipment to tighter levels, and as other problems arise that were insignificant to processes above 100 nanometers, process and equipment engineers look for new and innovative ways to better control semiconductor processing.

Semiconductor processing systems generally use robots to precisely move wafers around within the processing system. The motion and calibration of such robots is accordingly critical. For example, if the location where a robot is to deposit, or otherwise place, a wafer is mis-calibrated by a fraction of a millimeter, the brittle and fragile semiconductor wafer can crash into the processing equipment thereby damaging the wafer, and/or the equipment itself. If the calibration of the point where the wafer is to be deposited (a so-called “handoff point”) is off by a fraction of a millimeter in the other direction, the wafer may not come to rest properly upon the semiconductor processing equipment, and the hand-off, or transfer operation from the robot end effector to the processing equipment may fail.

Teaching the hand-off coordinate(s) to semiconductor wafer handling robots is a tedious and error-prone process. Methods do exist for such teaching, but they are generally disfavored. One method includes gripping a test wafer with a robotic end effector and then moving the robot using a teaching pendant until the technician observes the wafer in a desired relationship to the cooperating wafer support. Then, the robot joint coordinates are recorded for future reference. One weakness of this method is that the technician may accidentally cause the robot to crash the wafer and/or end effector into obstacles such as FOUP shelves. Crashes may result in undesirable contamination and may damage the wafer or end effector or obstacle. Yet another weakness of this method is that different technicians tend to make different judgments. A further weakness is that the method is not easily automated.

Automatic calibration of a wafer-handling robot is taught in U.S. Pat. No. 6,934,606 B1. While that reference teaches the automation of wafer handling robot teaching, the system generally requires that the robotic end effector and/or process equipment be adapted, to some extent, to facilitate the automation.

Providing an automatic semiconductor wafer handling robot teaching system that does not require changes to the robotic end effectors or the processing equipment itself, would represent a significant advance in the art of semiconductor wafer handling robots.

### SUMMARY

A method of calibrating a robot in a processing system is provided. The method includes removably coupling a distance sensor to an end effector of the robot and causing the distance sensor to measure a distance from the sensor to a substrate support. Then it is determined whether the distance meets or is within a selected threshold. Robot joint positions are recorded when the distance meets or is within the selected threshold.

### BRIEF DESCRIPTION OF THE DRAWINGS

FIG. 1 is a diagrammatic view of a wireless distance sensor for use in automatically teaching semiconductor wafer handling robots in accordance with an embodiment of the present invention.

FIG. 2 is a block diagram of a wireless automatic teaching sensor for semiconductor processing robots in accordance with an embodiment of the present invention.

FIG. 3 is a bottom plan view of a teaching sensor for a processing system in accordance with an embodiment of the present invention.

FIG. 4 is a front elevation view of a teaching sensor in proximity to a front opening unified pod (FOUP) in which a teaching fixture is present in accordance with an embodiment of the present invention.

FIG. 5 is a flow diagram of a method of calibrating a semiconductor processing robot in accordance with an embodiment of the present invention.

### DETAILED DESCRIPTION

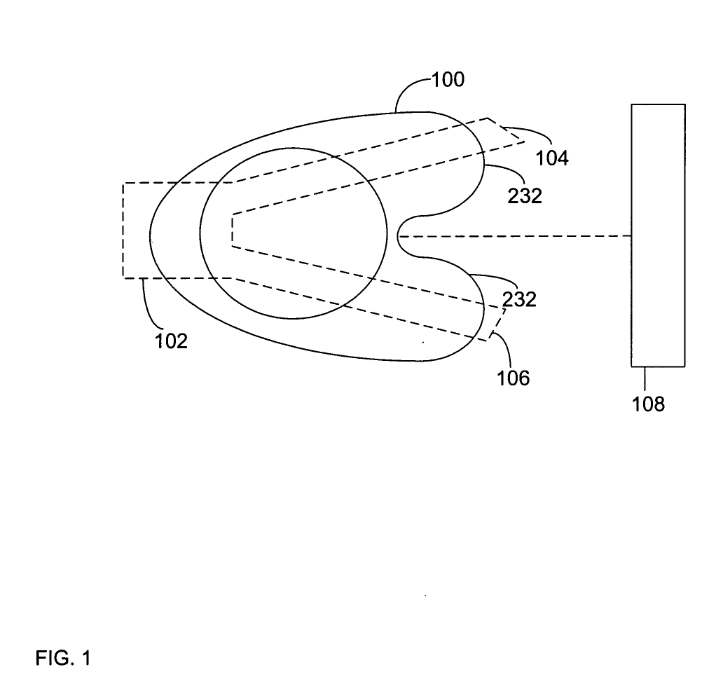

FIG. 1 is a diagrammatic view of a distance sensor for use in automatically teaching semiconductor wafer handling robots in accordance with an embodiment of the present invention. Sensor 100 is disposed upon end effector 102 of a semiconductor wafer handling robot (not shown) . End effector 102 includes a pair of bifurcated fingers 104, 106. Sensor 100 is sized to be smaller than a substrate of the processing system, and preferably is shaped such that it is inherently very stable resting upon end effector 102. As illustrated in FIG. 1, the shape of sensor 100 may approximate that of the end effector and bifurcated fingers. However, any suitable shape that is able to avoid interferences with FOUP shelves and other obstacles in the robot work volume can be used in accordance with embodiments of the present invention.

Sensor 100 is able to sense a distance from sensor 100 to a cooperating wafer support, illustrated diagrammatically at 108. As will be set forth in greater detail below, any suitable distance measurement technique for determining distance in one to six degrees of freedom can be used in accordance with embodiments of the present invention. It is preferred that sensor 100 include a non-substrate-like shape, meaning that it is not shaped and sized similarly to the substrates that are processed by the system. Additionally, while much of the disclosure will be described with respect to semiconductor wafer handling robots, similar technology is used for processing LCD flat panels, and reticles. Accordingly, in embodiments where the processing system is a semiconductor wafer processing system, sensor 100 simply needs to be smaller than and shaped distinctly from a semiconductor wafer.

The distance measured by sensor 100 to cooperating wafer support 108 can be displayed locally, to a technician, communicated wirelessly via a suitable wireless communication technology, or both. Further, sensor 100 can simply provide a suitable indication such as an indicator light, or an audible alarm, when a pre-set distance threshold is crossed. When the pre-set distance is measured, or otherwise detected, the joint coordinates of the processing robot are recorded, either manually or automatically, for future reference. This can be done by instructing the technician to manually or automatically record the joint coordinates. Additionally, this can be done by communicating with the robot controller to provide an indication that the distance threshold has been met, and that the current joint coordinates of the robot should be recorded by the robot controller for future reference.

The non-substrate-like shape of sensor 100 helps reduce or eliminate interferences with FOUP shelves and other obstacles in the robot work volume. Additionally, the non-substrate-like shape helps reduce the weight of the sensor and thereby reduces robot arm/end effector droop measurement artifacts.

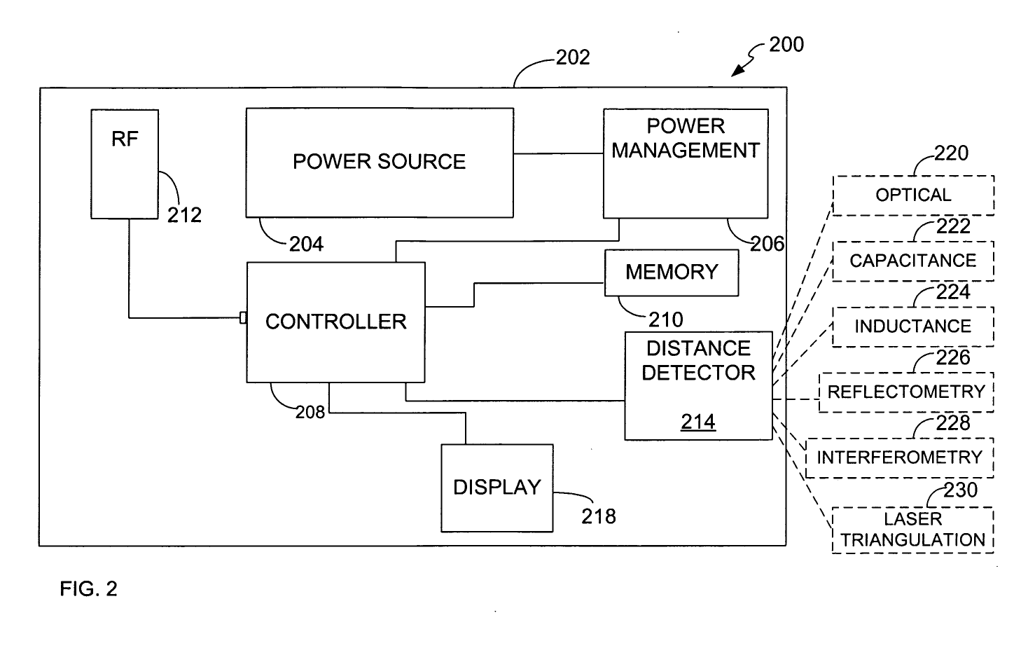

FIG. 2 is a block diagram of a wireless automatic teaching sensor for semiconductor processing robots in accordance with an embodiment of the present invention. Sensor 200 includes electronics enclosure 202. Disposed within electronics enclosure 202 are power source 204, power management module 206, and controller 208. Additionally, memory 210 is also disposed within enclosure 202 and is coupled to controller 208. Further still, radio frequency module 212 is disposed within enclosure 202 and coupled to controller 208.

While distance sensor 214 is illustrated in FIG. 2 as being disposed within enclosure 202, it may form part of enclosure 202, or may be disposed proximate, but external to enclosure 202.

As illustrated in FIG. 2, power source 204 is preferably a battery disposed within enclosure 202 and is coupled to controller 208 via power management module 206. However, power source 204 can include any device that is able to provide a sufficient amount of electrical energy. Exemplary devices can include known power storage devices, such as batteries, capacitors, et cetera, as well as known energy harvesting devices, and any combination thereof.

Preferably, power management module 206 is a power management integrated circuit available from Linear Technology Corporation under the trade designation LTC3443. Controller 208 is preferably a microprocessor available from Texas Instruments under the trade designation MSC1211Y5. Controller 208 is coupled to memory 210, which can take the form of any type of memory, including memory that is internal to controller 208 as well as memory that is external to controller 208. The preferred controller includes internal SRAM, flash RAM, and a boot ROM. Memory module 210 also preferably includes external flash memory having a size of 64K×8. Flash memory is useful for storing non-volatile data such as programs, calibration data, and/or non-changing data as may be required. The internal random access memory is useful for storing volatile data relevant to program operation.

Controller 208 is coupled, via a suitable port, such as a serial port, to radio frequency communication module 212 in order to communicate with external devices. In one embodiment, radio-frequency module 212 operates in accordance with the well-known Bluetooth standard, Bluetooth core specification version 1.1 (Feb. 22, 2001), available from the Bluetooth SIG (www.bluetooth.com). One example of module 212 is available form Mitsumi under the trade designation WMLC40. Additionally, other forms of wireless communication can be used in addition to, or instead of, module 212. Suitable examples of such wireless communication include any other form of radio frequency communication, acoustic communication, infrared communication, communication employing magnetic induction, or combinations thereof.

Controller 208 is coupled to distance sensor 214 which is configured to sense the distance to cooperating wafer support 108 (shown in FIG. 1). The measured distance may have from 1 to 6 degrees of freedom. Six degrees of freedom includes x, y, z coordinates as well as roll, pitch, and yaw rotational components.

Sensor 200 preferably includes a display 218 that is configured to provide an indication relative to distance, either being an absolute distance measurement, or an indication of whether the distance is within or at a selected threshold. Thus, embodiments of the present invention include not only moving the robot end effector until the measured distance is within a certain threshold, but also simply measuring the distance, and responsively causing a certain end effector displacement before recording robot joint positions.

Distance detector 214 can include any type of suitable distance sensing technology. Suitable examples of distance sensing technologies include optical sensing techniques 220; capacitance distance sensing techniques 222; inductance-based distance sensing techniques 224; reflectometry-based distance sensing techniques 226; interferometry-based distance techniques 228; and laser triangulation distance sensing techniques 230. These various techniques can be used as alternates, or distance sensor 214 can use any suitable combination of such techniques. For example, while one type of technique may be highly useful for absolute distance sensing, it may not have extreme precision that another technique has. For example, distance detector 214 may use a combination of laser triangulation 230 and capacitance-based distance sensing 222. In this embodiment, the distance is initially sensed by laser triangulation technique 230, and as the selected threshold approaches, the distance measurement can be switched to employ solely the capacitance-based measurements 222.

An example of an optical-based distance measurement 220 includes the provision of a camera, or image sensor within distance detector 214 that observes a feature, whether artificial or naturally occurring within the robot work volume. A priori knowledge of the feature can then be used in combination with an image of the feature to discern distance information.

An example of capacitance-based distance sensing includes providing a pair of conductive plates proximate edges 222 (shown with respect to FIG. 1) such that a metallic object proximate edges 222 will generate a capacitance that varies with respect to the distance. The capacitance can then be used as an indication of the distance.

Inductance-based technique 224 is a sensing regime that is somewhat similar to capacitance-based sensing 222 described above. In this regard, one or more inductive-based emitters can be provided proximate a suitable edge of the sensor, and the inductive sensors then sense the presence of a metallic, magnetic, object within the electromagnetic field generated by the inductive field generators.

Reflectometry-based distance sensing 226 includes any technique that uses a reflected beam or image from cooperative substrate support 108 to provide an indication of distance. Accordingly, if a laser beam is directed toward substrate support 108 at a slight angle, the reflected angle will be equal to the incident angle, and the lateral position of the reflected beam upon sensor 200 will be an indication of the distance.

Inteferometric measurement technique 228 includes passing illumination through a slit, or other suitable structure, to generate an interferometric pattern. The distance between the light and dark regions in the pattern on substrate support 108 then provides an indication of the distance between the sensor and substrate support 108.

Finally, laser triangulation 230 is a relatively simple technique where a laser is directed towards object 108 at a slight angle, such that the position of the laser beam striking substrate support 108, as viewed from sensor 200, will be based upon the distance between the sensor and object 108.

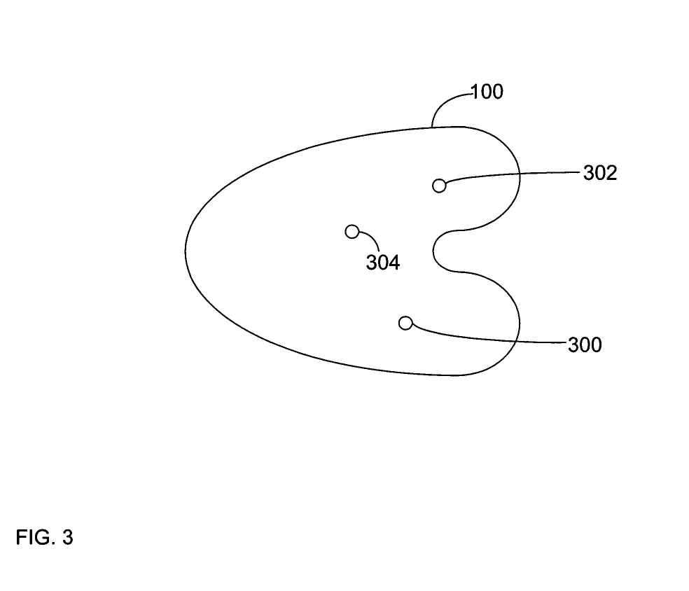

FIG. 3 is a bottom plan view of a teaching sensor for a processing system in accordance with an embodiment of the present invention. As can be appreciated, the distance registered by sensor 100 is used as a direct indication of the distance from the end effector to the cooperating wafer support 108. Accordingly, any variations in the position of sensor 100, which is removably held upon the end effector, will introduce error into the overall calibration system. Accordingly, embodiments of the present invention preferably include structural features or artifacts that ensure that sensor 100 is held in the same exact position on the end effector every time that the end effector couples to the sensor. Such precise registration can be facilitated by employing an edge-gripping end effector. However, embodiments of the present invention also include the adaptation of the bottom side of the sensor 100. FIG. 3 is a bottom plan view of sensor 100 illustrating a kinematic mount consisting of exactly three pins 300, 302, 304 that cooperate to engage the end effector 102. Additionally, or alternatively, the bottom surface of sensor 100 can include other features such as shoulders that register the sensor to the end effector 102. Additionally, sensor 100 can be engaged with vacuum from the end effector to more effectively adhere the sensor to the end effector 102.

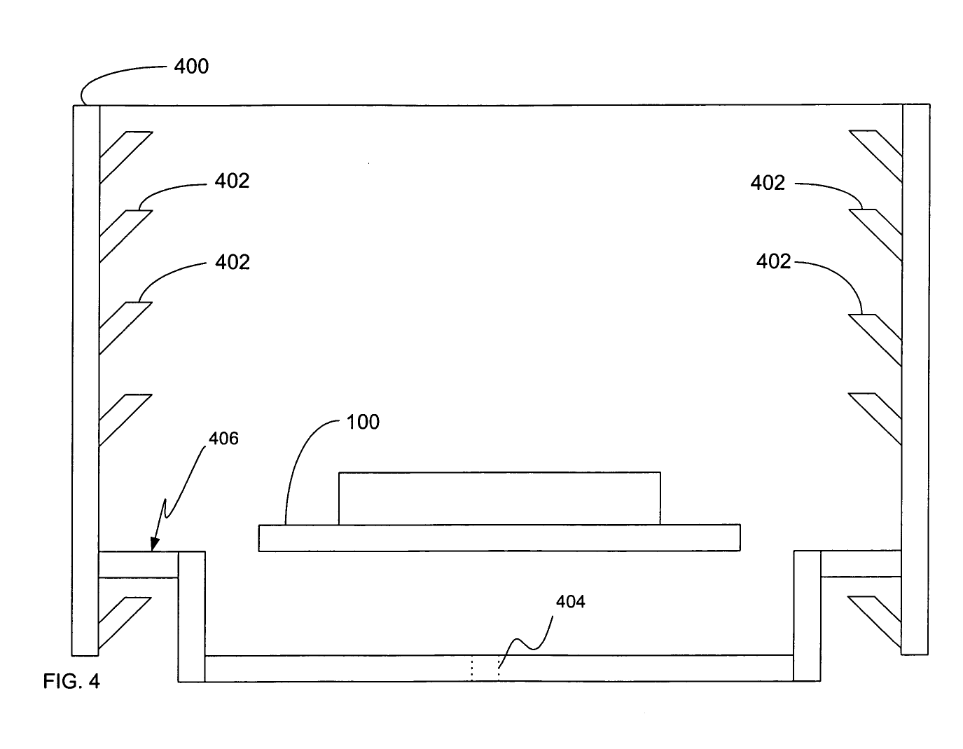

FIG. 4 is a front elevation view of a teaching sensor in proximity to a front opening unified pod (FOUP) in which a teaching fixture is present. FOUP 400 includes a plurality of slots or shelves 402 which generally hold, or maintain the processing substrates, such as semiconductor wafers. As illustrated in FIG. 4, sensor 100 has a width that is significantly narrower than the distance between the shelves. Additionally, FIG. 4 illustrates a generous clearance between sensor 100 and the FOUP as well as the fixture. The teaching fixture is supported and registered by the FOUP 400 shelf. A mark or other feature such as a hole 404 is present on the fixture 406 that can be recognized and detected by a camera type distance measuring sensor. Fixture 406 provides feature 404 which has a known geometric relationship to the center of the FOUP slot that supports fixture 406. Typically, two slot positions are taught. Embodiments of the present invention include employing any suitable number of fixtures, including one, to teach slot positions. When two slot coordinates are taught, the substrate handling robot is then able to measure the slot pitch and the orientation of the FOUP (eg: inclined to the front/rear of left/right) as well as the location of the FOUP 400 in the robot's coordinate system.

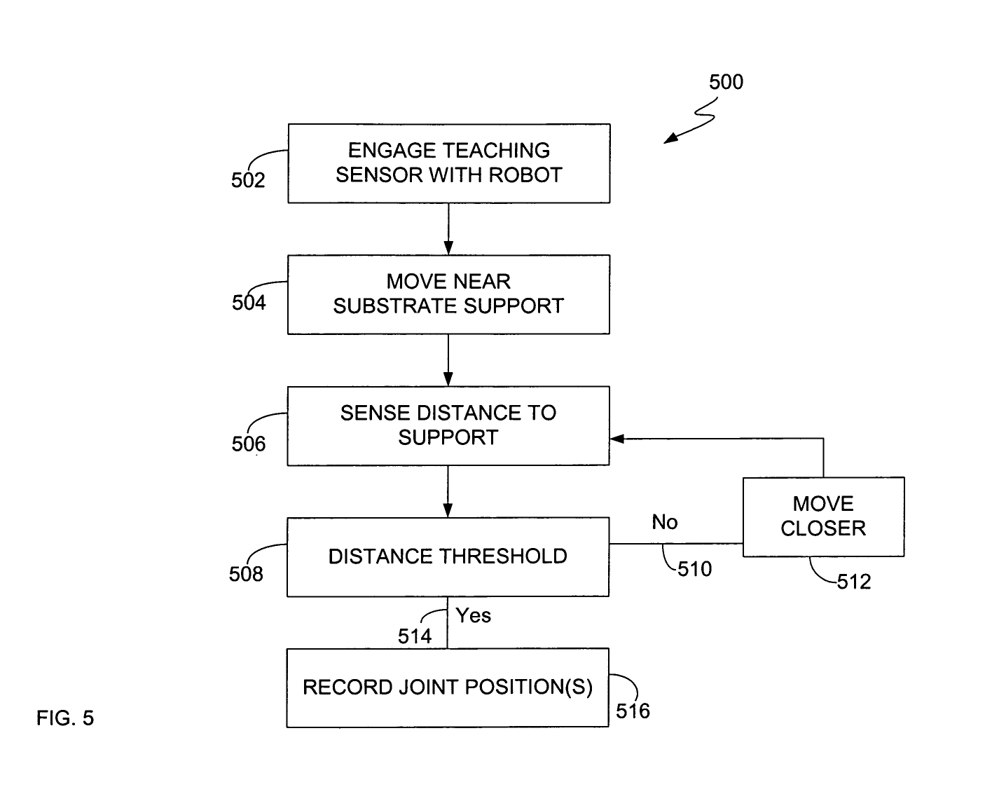

FIG. 5 is a flow diagram of a method of calibrating a semiconductor processing robot in accordance with an embodiment of the present invention. Method 500 begins at block 502 where the handling robot of the semiconductor processing system engages, or is otherwise coupled to, an automatic teaching sensor. Once the sensor is engaged with the end effector of the robot, block 504 executes and the end effector is brought near a substrate support, such as substrate support 108 illustrated in FIG. 1. Once the requisite rough proximity has been achieved, block 506 executes where the distance to the support is sensed. Then, at block 508, it is determined whether the sensed distance meets or is within a selected threshold. If the distance does not meet the selected threshold, control passes along line 510 to block 512 which moves the end effector closer to the substrate support, and the distance is sensed again. This process repeats until the distance meets or is within the selected threshold, at which time control passes along line 514 to block 516 where the joint position(s) of the handling robot are recorded. This entire method is repeated for each relevant substrate support within the processing system.

Although the present invention has been described with reference to preferred embodiments, workers skilled in the art will recognize that changes may be made in form and detail without departing from the spirit and scope of the invention.

What is claimed is:

1. A method of calibrating a robot in a processing system, the method comprising:
removably coupling a distance sensor to an end effector of the robot;
causing the distance sensor to measure a distance from the sensor to a substrate support;
determining whether the distance meets or is within a selected threshold; and
recording robot joint positions when the distance meets or is within the selected threshold.

2. The method of claim 1, wherein the distance sensor communicates the measured distance via wireless radio-frequency communication.

3. The method of claim 1, wherein the sensor includes a distance detector that employs at least one distance measuring technique selected from the group consisting of optical-based distance measurement, capacitance-based distance measurement, inductance-based distance measurement, reflectometry-based distance measurement, inteferometric-based distance measurement and laser triangulation.

4. The method of claim 1, wherein the processing system is configured to process substrates, and wherein the sensor is smaller than the substrates.

5. The method of claim 1, wherein removably coupling the end effector to the sensor includes engaging the end effector with cooperative features on the sensor.

6. A method of calibrating a robot in a processing system, the method comprising:
removably coupling a distance sensor to an end effector of the robot;
causing the distance sensor to measure a distance from the sensor to a substrate support;
responsively displacing the end effector based upon the distance measured by the distance sensor; and
recording robot joint positions when the distance meets or is within the selected threshold.

7. The method of claim 6, wherein the distance sensor communicates the measured distance via wireless radio-frequency communication.

8. The method of claim 6, wherein the sensor includes a distance detector that employs at least one distance measuring technique selected from the group consisting of optical-based distance measurement, capacitance-based distance measurement, inductance-based distance measurement, reflectometry-based distance measurement, inteferometric-based distance measurement and laser triangulation.

9. A sensor for sensing a distance from a robot end effector to a substrate support in a substrate processing system, the sensor comprising:
an enclosure sized smaller than a typical substrate of the substrate processing system;
a power source disposed within the enclosure;
a controller coupled to the power source; and
a distance detector operably coupled to the controller and configured to measure a distance to the substrate support.

10. The sensor of claim 9, and further comprising a wireless communication module operably coupled to the controller.

11. The method of claim 9, wherein the the distance detector employs at least one distance measuring technique selected from the group consisting of optical-based distance measurement, capacitance-based distance measurement, inductance-based distance measurement, reflectometry-based distance measurement, inteferometric-based distance measurement and laser triangulation.
